(19) United States
(12) Patent Application Publication
(10) Pub. No.: US 2008/0266136 A1
(43) Pub. Date: Oct. 30, 2008

(54) Emergency traffic signal system and apparatus

(76) Inventor: Keyvan T. Diba, Los Angeles, CA (US)

Correspondence Address: LAUSON & SCHEWE LLP, 880 APOLLO STREET, SUITE 301, EL SEGUNDO, CA, 90245, US

(21) Appl. No.: 12/079,643

(22) Filed: Mar. 28, 2008

Related U.S. Application Data
(60) Provisional application No. 60/926,266, filed on Apr. 26, 2007.

(51) Int. Cl. G08G 1/087

(52) U.S. Cl. 340/906

(57) ABSTRACT

The present invention provides an attachment installed unobstructively on a visor about a lens of a traffic signal and configured to receive a preemptive signal from an emergency or other authoritative source and transmit a correlating message visually or audibly to a surrounding citizenry via a display and optionally a speaker. The attachment can include one of a variety of display means to animatedly or statically communicate a directive to the citizenry. An optional series of LEDs can be included to draw attention to the directive as displayed. The directive can communicate an action to be taken by the citizenry, the type of vehicle approaching, or a route to be followed. Optionally, the frame or display may be shaped at least in part similarly to a standard street sign. The attachment provides a way to quickly and clearly direct people in a manner that clears a path for authorities.

### RELATED APPLICATION DATA

This application claims the priority date of provisional application No. 60/926,266 filed on Apr. 26, 2007.

### BACKGROUND OF THE INVENTION

1. Field of the Invention

This present invention is directed to emergency traffic signal indicators for controlling or directing vehicle traffic and more particularly, is directed to traffic signal indicators which complement existing traffic signals and present highly visible visual warnings or messages to drivers in emergency or other situations.

2. Description of the Related Art

Traffic signals have been used for many years to regulate traffic flow at intersections, typically providing a green or “go” light for traffic on one street at preselected intervals while providing traffic on the intersecting street with a red or “stop” light. During the transition from “go” to “stop,” it is customary to provide a yellow or “caution” light for a short interval, warning oncoming motorists to prepare to stop when the red light appears. All three lights often are mounted in a common housing or frame, usually in a vertical row but sometimes horizontally aligned.

When an emergency vehicle such as a police car, fire truck or ambulance must pass rapidly through an intersection, the oncoming emergency vehicle typically sounds an audible warning such as a siren and a visual warning such as a flashing light, and then proceeds through the intersection without regard to the existing condition of the traffic signal. For various reasons, these signals are not always sufficient to avoid collisions. Loud noises, closed vehicles with radios or other audio devices playing, hearing impaired drivers and inattentive drivers in some instances lead to dangerous situations in which cross traffic does not stop for the oncoming emergency vehicle, with resulting collisions.

A variety of devices have been proposed to allow emergency vehicles to control traffic signals. Such conventional systems typically use radio transmitter systems for activating emergency preemption controls on the traffic signals that will override the normal controls of the signals and provide “stop” signals for cross traffic approaching the intersection and continuous “go” or green signals for the emergency vehicle.

Other special signals have been used in efforts to provide information to drivers regarding the presence and direction of approach of emergency vehicles, whether on intersecting streets or from one direction or the other on the same street. Such systems and devices are well known, and examples are shown in U.S. Pat. Nos. 4,775,865 and 4,704,610 (signs beside traffic signals with vehicle symbols for indicating approaching emergency vehicles), U.S. Pat. No. 6,292,109 (display at corner of intersection with sign having arrows indicating the direction of an approaching vehicle, a traffic signal with a siren and a flashing red emergency light), and U.S. Pat. No. 6,362,749 (signal device installed in vehicles and having arrows for indicating the direction of the signal from an approaching emergency vehicle, which also could be installed in an undisclosed manner on a traffic signal).

Yet another device is shown in the patent issued to the inventors of the present application, that patent being U.S. Pat. No. 6,847,306. Disclosed is an attachment for a traffic signal that has an electro-optically responsive panel that completely covers one lens of the signal and overrides that signal lens in the case of the reception of a preemptive signal. This system may not be desirable in all applications due to certain governmental regulations forbidding the obscuring, covering or overriding of the traffic lens.

Many of these conventional devices, systems and methods have provided ambiguous and sometimes confusing information to drivers and often have been so complex and expensive in construction that they have not been universally installed. These conventional systems do not provide adequate warning to drivers in special traffic situations that require the driver's special attention such as at railroad crossings and bus crossings. Other conventional systems have been unreliable in operation or have required substantial time and money for maintenance. And yet others, undesirably obscure part of the traffic lenses. Thus, there is a need for an improved emergency traffic signal system and apparatus.

### OBJECTS OF THE INVENTION

It is an object of the present invention to provide an improved device secured to a traffic signal for communicating a warning message to citizenry as received by a preemptive signal originating from an authoritative vehicle;

It is a further object of the present invention to provide improved attachment of the device adaptable to conventional traffic signals, e.g., installed unobstructively about or proximate a lens of a traffic signal so as to not obscure the lens;

It is a further object of the present invention to provide an improved attachment that communicates the civic message visually, and as an option, audibly;

It is a further object of the present invention to provide an improved attachment that may optionally include a means to further emphasize the civic message and draw the viewer's eye to the message;

It is a further object of the present invention to provide an improved attachment that may optionally be wholly or in part shaped like a standard traffic sign to permit faster understanding of the civic message; and

It is a further object of the present invention to provide an improved attachment that animatedly communicates a directive that could optionally include the direction of travel of the authoritative vehicle, the type of authoritative vehicle, or an evacuation route.

These and other objects and advantages of the present invention will become apparent upon reading the following detailed description and upon reference to the accompanying drawings.

### SUMMARY OF THE INVENTION

The present invention is directed to a novel emergency traffic signal apparatus and system fitted onto conventional traffic signals without interfering with the normal traffic signal operation and which provide improved visual notification and warning communications to drivers in the form of civic messages.

In the preferred embodiment of the present invention an attachment for a conventional traffic signal is provided. The attachment is powered by a municipal source, such as provided through the power grid, which also powers the traffic signal. The traffic signal includes at least one signal lens shrouded by a visor. The attachment is in occasional communication with an authoritative vehicle emitting a preemptive signal. The attachment preferably comprises a housing configured to receive the traffic signal proximate to the lens area so that an unobstructed view of the signal lens is maintained. The housing further includes a display for visually communicating a warning message and a sensor for receiving the preemptive signal from the authoritative vehicle. Further included is a controller in communication with the sensor to direct the display to show the warning message corresponding to the received preemptive signal

In one embodiment of the invention, the attachment includes a housing with an aperture formed through it. The aperture is sized to receive the visor of a standard traffic signal, so that the aperture is fitted around the visor and does not obscure or interfere with the viewing of the signal lens. Thus the attachment is supported without obscuring the signal lens. The housing is also configured to provide weather resistant protection for the electronics and components housed therein. These electronics include a display that is configured to visually communicate a warning message or other civic message to a citizenry and alert them to an appropriate course of action, a sensor to receive a preemptive signal from a authoritative vehicle, and a controller that is configured to receive a signal from the sensor and direct the display means to display the civic message corresponding to the signal. The attachment is preferably powered by a municipal source, although, optionally, an auxiliary battery can be included in the housing or other location. A battery may be preferred if the municipality indicates that the attachment should provide a flashing stop signal or message in a power outage. The controller is preferably a printed circuit board (PCB), but could include other means to receive a signal, process the signal and provide instruction to the display, speaker and other communications means, or to provide instruction for other components, or other functions commonly known in industry.

The preferred location of the attachment on the traffic signal is on its visor over the yellow signal lens, usually in the middle of the three lights, i.e. green, yellow and red. This location is preferred due to the average driver's attentive focus on the yellow light. However, the invention can be attached to any of the available visors.

The display means can be any powered display that can visually communicate a message to drivers, pedestrians, or any citizenry in proximity to the traffic signal. The display can made from an array of LEDs that can be selectively activated to produce a graphic or an animation. These LEDs can all be of a single color, or varied colors, or each LED could be capable of producing a range of colors, such as tri-colored LEDs or other available LED technologies. Alternative variations for the display can include a CRT, LCD, PDP, or rotating LED (LED columns spaced about a spinning drum).

In further embodiments, the invention could include a speaker to audibly communicate the civic message. And, alternatively, the attachment can receive a preemptive message from a source that is outside of the attachment, such as an existing preemptive signal receiver. This speaker is preferably mounted inside the housing to substantially protect it from the elements.

In another embodiment, the attachment may have a series of LEDs or similar lights installed on a front face or other visible location of the housing and are configured to emphasize the civic message by drawing attention to the display. They can be positioned in any order, although preferably they are positioned partially circumferentially around the aperture; and they can be configured to illuminate individually, collectively or sequentially during the display of the civic message. In one format, the LEDs are arranged in a sideways U-shaped series. They can be configured to flash sequentially from one side of the aperture, one sequence progression traveling clockwise and the other counterclockwise, transitioning to the linear portion of the U, flashing towards the display to attract attention to the display.

In yet another embodiment, the screen and/or the distal end (furthest from the visor) of the housing can be shaped to mimic an outer geometry of a standard street sign, such as a round shape for round signs or signals, semi-octagon shaped for octagonal signs (stop signs), semi-triangle shaped for triangular signs (warning signs), chevron shaped for diamond shaped signs (warning signs, merge, signs, etc.), or rectangular shaped. The displayed image is positioned at the distal end of the display, substantially nesting within the shape, such as a stop sign nesting within the semi-octagon shape of the distal end. The entire display can additionally be pennant or arrow shaped to further emphasize a directive to merge one way, possibly being enhanced by an animated streaming chevron image.

An authoritative vehicle is defined as any public or private vehicles that have right of way on any road or intersection and the authority to preempt traffic signals, which include ambulances, police vehicles, fire department vehicles, any emergency vehicle, buses, trains, and the like. Each of the authoritative vehicles can have a distinctive preemptive signal that can be recognized by the sensor. The sensor, in turn, can individualize the displayed image to match the authoritative vehicle. For example, a graphical or animated graphic image of the authoritative vehicle can be displayed; and that animation can visually show the graphic traveling in a direction that correlates with the direction of travel of the actual vehicle. Or, an authoritative symbol associated with the authoritative vehicle can be displayed, such as a badge for the police or cross for an ambulance. Or, alternatively, a known correlative symbol can be used, such as a flame for a fire truck or a wave or hurricane symbol to indicate an evacuation route. These individualized preemptive signals can be transmitted on unique signals of differing frequencies or spectrum, that are known to those skilled in the art.

The attachment can provide a civic message that animatedly indicates a directive to a citizenry (any surrounding people, in cars, pedestrians, on a bike, and so on). That directive can be a stop directive, a yield directive, a yield right directive, a go directive, a detour directive or an evacuation directive.

There are additionally preferred methods of using the attachment as described above comprising the steps of providing the attachment as substantially described above in one or combinations of embodiments and configured to be attached to a traffic signal with a plurality of lenses, installing the attachment unobstructively about one of said lens, receiving a preemptive signal from an authoritative vehicle via the sensor, processing the signal in the controller to determine a warning message and showing the warning message for viewing by the citizenry. The attachment is configured for displaying the message on the display using a familiar and easy to understand graphic that can tell drivers, pedestrians, cyclist, and other people how to react in response to the approach of an authoritative vehicle, such as an ambulance, police vehicle, bus, train, or any other vehicle with preemptive authority.

### BRIEF DESCRIPTION OF THE SEVERAL VIEWS OF THE DRAWINGS

FIG. 1 is a perspective view of an embodiment of the improved emergency signal system and apparatus of the present invention.

FIG. 2 is an exploded view of an embodiment of the improved emergency signal system and apparatus of the present invention.

FIG. 3 is an exploded view of another embodiment of the improved emergency signal system and apparatus of the present invention.

FIGS. 4A-C are front perspective views of an embodiment of the present invention attached to a traffic signal and displaying some of the possible directives.

FIG. 5 is a perspective view of an intersection with magnified views of the attachment secured to a signal showing a yield right directive and the resulting view and action of the drivers.

FIG. 6 is a perspective view of an intersection with magnified views of the attachment secured to a signal showing a stop directive and the resulting view and action of the drivers.

FIGS. 7A-C are front perspective views of the operation of one embodiment of the invention showing the display of graphics and icons to alert drivers.

FIGS. 8A-C are front perspective view of the operation of another embodiment illustrating the octagonal housing configuration.

FIGS. 9A-C are front perspective views of embodiments of the invention with the Light-Emitting Diode Display Option, the Liquid Crystal Display Option and the Cathode-Ray Tube Display Option.

FIGS. 10A-C are front perspective views of embodiments of the invention with an arrow or pennant housing configuration.

FIGS. 10A-C are front perspective views of further embodiments of the invention with the Light Emitting Diode (LED) Strobing Drum configuration.

FIG. 12 is an exploded view of an embodiment of the improved emergency signal system and apparatus of the present invention showing the rotating or strobing LED display.

### LISTING OF REFERENCE NUMERALS OF FIRST-PREFERRED EMBODIMENT

attachment 20

traffic signal 22

signal lens 24

visor 26

front face 28

front housing 30

back housing 31

aperture 32

display 34

sensor 36

preemptive signal 38

authoritative vehicle 40

controller 42

speaker 44

battery 46

individual LEDs 48

LED panel 50

perforations 52

arrow 54

vehicle 56

vehicle 58

driver 60

vehicle 62

vehicle 64

driver 66

distal end 68

semi-octagonal housing 70

arrow 72

LCD 74

CRT 76

### Listing of Reference Numerals of First-Preferred Embodiment

pennant housing 78

arrow 80

LED strobing drum 82

rotating LED 84

front housing 86

back housing 88

gearing 90

battery 92

motor 94

sensor 96

### Description of the Preferred Embodiments

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

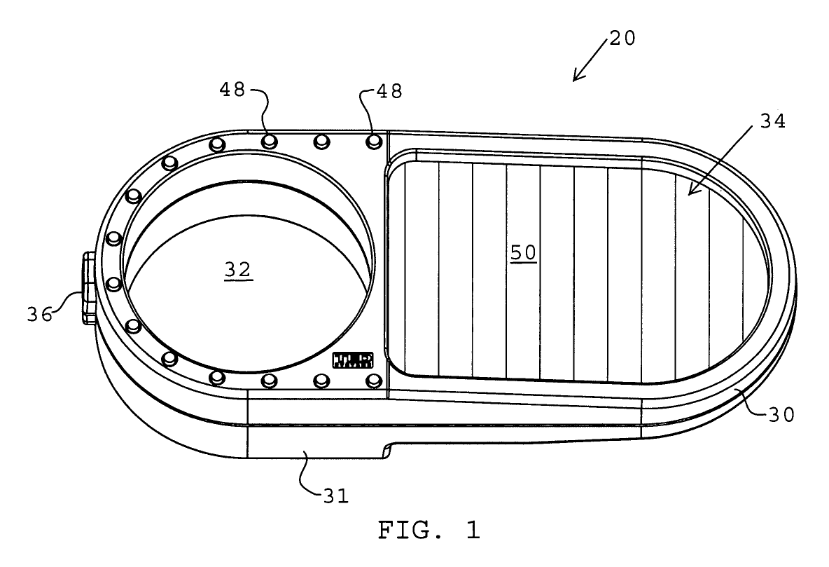

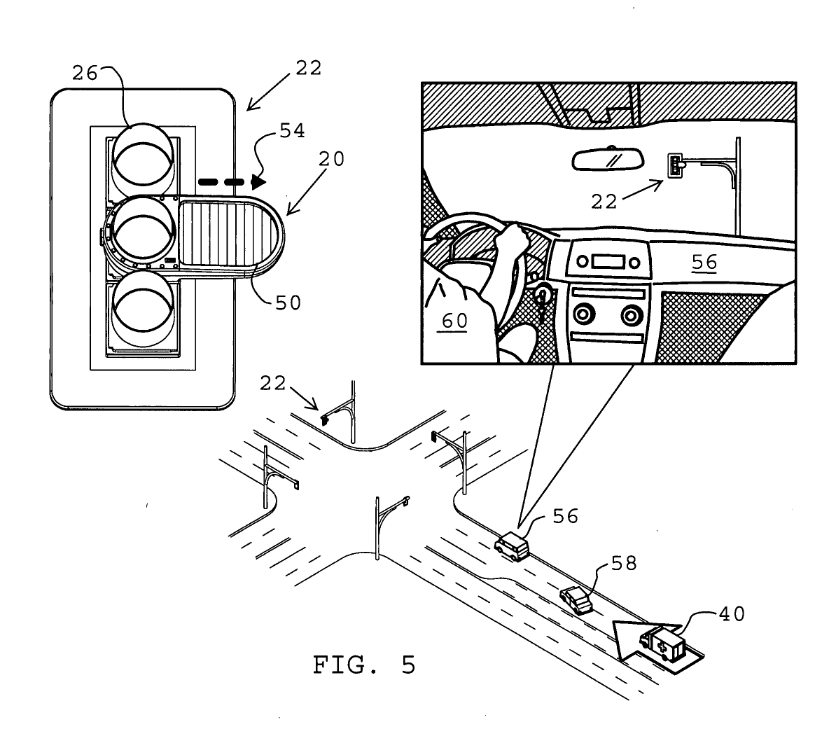

Referring to FIG. 1, the attachment 20 is shown in one or more embodiments of the inventive apparatus and system. The attachment 20 is generally elongated and rounded in shape and configured to be mounted onto a conventional traffic signal 22 and fitted around the visor 26 a standard yellow or middle light section of the traffic signal 22, as shown in FIG. 5. In the configuration in FIG. 5, the attachment 20 does not block or obscure the light from the traffic signal 22 and shows the display 34, in the preferred case a LED panel 50, and sensor 36 in a manner that provides for the operation of the apparatus and system in one or more embodiments as described herein. The attachment 20 includes a series of individual LEDs 48 that are selectively illuminated and attached to a front face 28 of the front housing 30 in one or more embodiments as shown in FIG. 1. The sensor 36, shown to the left, is a standard type configured to receive a preemptive signal and are well known in well known in the art and are therefore not further discussed.

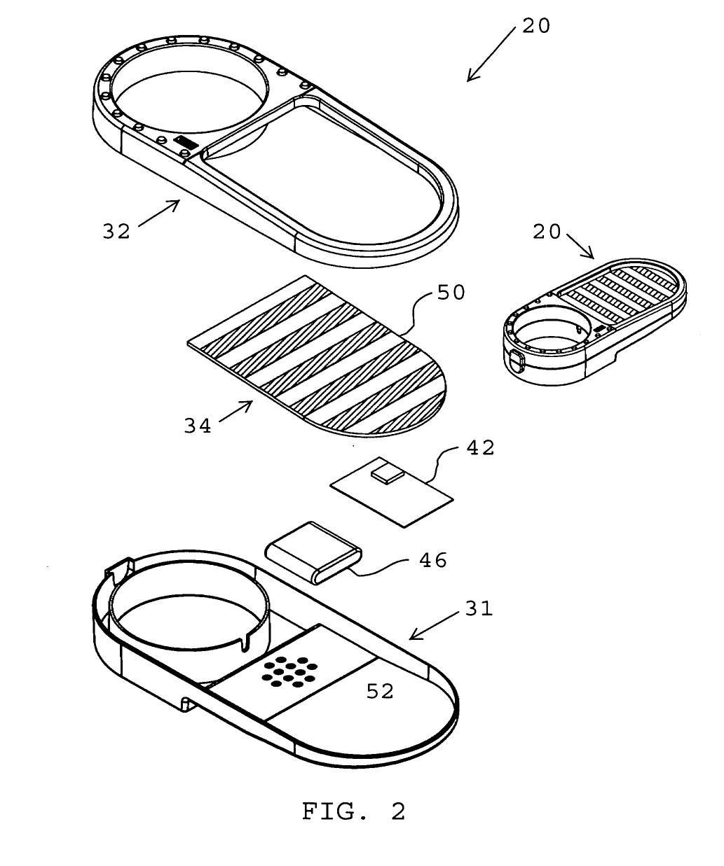

As shown in exploded detail in FIG. 2, the attachment 20 includes the front housing 30 and the complementary back housing 31 that fit together to form the attachment 20. The front housing 30 and rear housing 31 can be made by an injection molded plastic process but can be made of other materials and by other methods of manufacture all of which are within the scope of the invention. An LED panel 50 is placed onto the front face 28 in an opening in the front housing 20 that is adapted to display the LED panel 50. The controller 26, preferably a printed circuit board, is provided within the attachment 20 to control the operation of the LED panel 50 and other functions as discussed herein.

Looking at FIG. 2, a speaker (not shown) is provided in one or more embodiments where an audible signal is desired, and can be integrated or attached to the PCB or any part of the housing; perforations allow communication of the audible signal to the environment. The auxiliary battery 46 placed within the attachment 20 provides electrical power for the operation of all elements herein, the LED panel 50, the printed circuit board 42, sensor 36 and the speaker. The various elements disclosed herein are connected by electrical circuitry within the attachment 20 which is well known to persons skilled in the art and consequently is not shown in the Figures. In other embodiments, an external power source is used to provide electrical power for the various elements and the use of such external power sources are well known to persons skilled in the art and are not shown in the Figures.

The sensor 36 is secured on the exterior of the attachment 20 in the manner shown in FIG. 1 and FIG. 2. The sensor 36 electronically activates various features of the invention in response to signals received from oncoming civic or emergency vehicles or emergency vehicles coming from a crossing direction travelling on an intersecting street. The sensor 36 is connected by electrical circuitry to the printed circuit board 42 and other elements within the attachment 20. The use of signals from emergency vehicles to the sensor 36 to activate the features of the invention and the electrical circuitry to connect the sensor 36 to the elements within the attachment 20 are well known to persons skilled in the art and are not shown in the Figures.

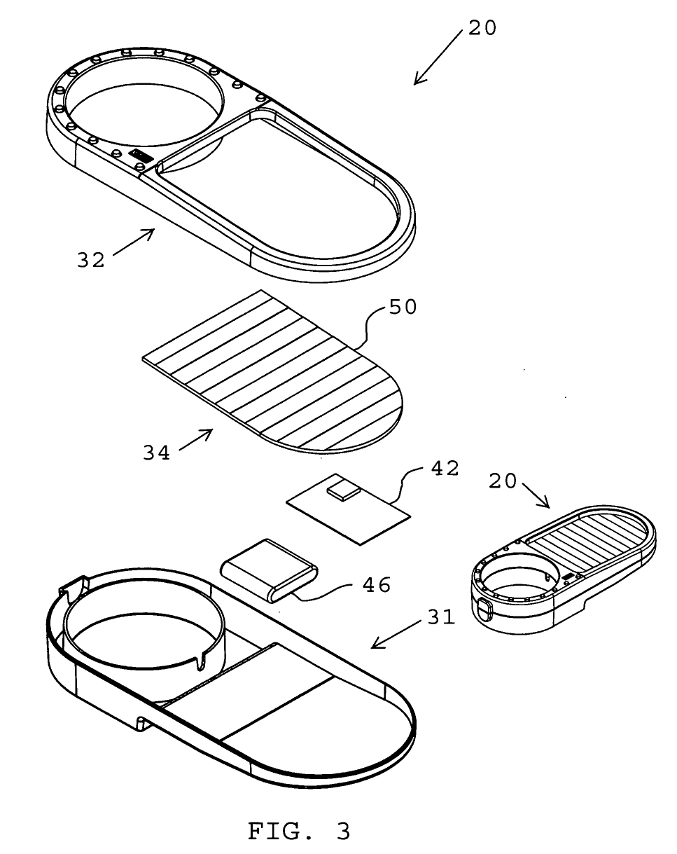

FIG. 3 shows an exploded view and a smaller perspective view of a further embodiment of the invention with the front housing 32 and the complementary rear housing 31 assembled together to form the attachment 20 without the speaker or perforations 52. The LED panel 50 is placed onto the front housing 32 in an opening in the front housing 32 that is adapted to display the LED panel 50. The printed circuit board 42 is provided within the attachment 20 to control the operation of the LED panel 50 and other functions discussed herein. The auxiliary battery 46 within the attachment 20 provides electrical power for the operation of all elements herein including the sensor 36 on the exterior of the attachment 20 as shown in FIGS. 1 and 3. The various elements disclosed herein are connected by electrical circuitry within the attachment 20 which is well known to persons skilled in the art and consequently is not shown in the Figures.

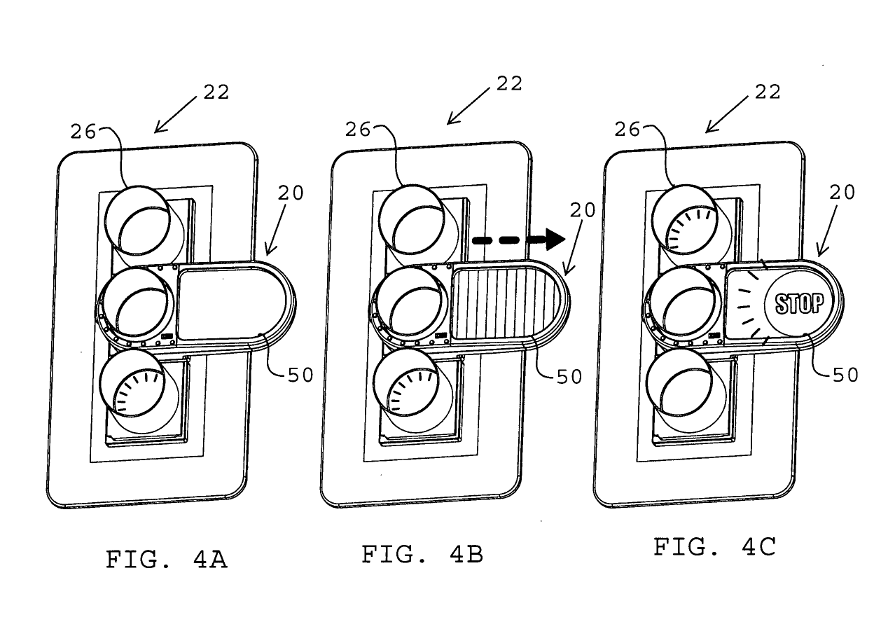

FIGS. 4A-C shows another embodiment of the invention where the attachment 20 includes an LED panel 50 that can display alternative civic or emergency messages including streaming chevrons alerting drivers to move to one side of the road, a Stop insignia, a flashing red light or other informative messages that alert drivers to situations that require their attention. The LED panel 50 is formed as a preferably flat array of light emitting diodes capable of producing contrasting patterns and is programmable to produce the desired color or pattern by persons skilled in the art.

The attachment 20 is secured to the traffic signal 22 by known and various securing means, such as clamping, bolting, frictional engagement, and any other appropriate means to secure the attachment 20 without disturbing the operation of the traffic signal 22. One mounting means could include a bracket or other known similar device that acts as a mounting interface, securing the attachment 20 to the traffic signal 22. Or, optionally, the attachment 20 can engage the visor 26 directly in frictional or clamping engagement through either the aperture 32, or by other means, such as a strap around the visor to hold the attachment 20 or optionally a C-clamp or similar that engages the frame of the traffic signal 22. Of course other mounting options are available, such as directly bolting the attachment 20 to the signal 22, or welding, adhering, and any other mounting options known in the art.

FIG. 5 illustrates one embodiment of the invention described in FIG. 4B. In FIG. 5, the authoritative or emergency vehicle 40 has transmitted an appropriate signal to activate the LED panel 50 via the sensor 36 so that the LED panel 50 displays a streaming configuration such as a series of chevrons in the direction of the arrow 52. This alerts the driver of vehicle 56 and the driver of vehicle 58 to move their respective vehicles to one side of the road in the direction of the streaming configuration as shown in FIG. 5. The magnified window view shown in FIG. 5 shows a view of the driver 60 of vehicle 56 in viewing the attachment 20 secured to the light signal 22.

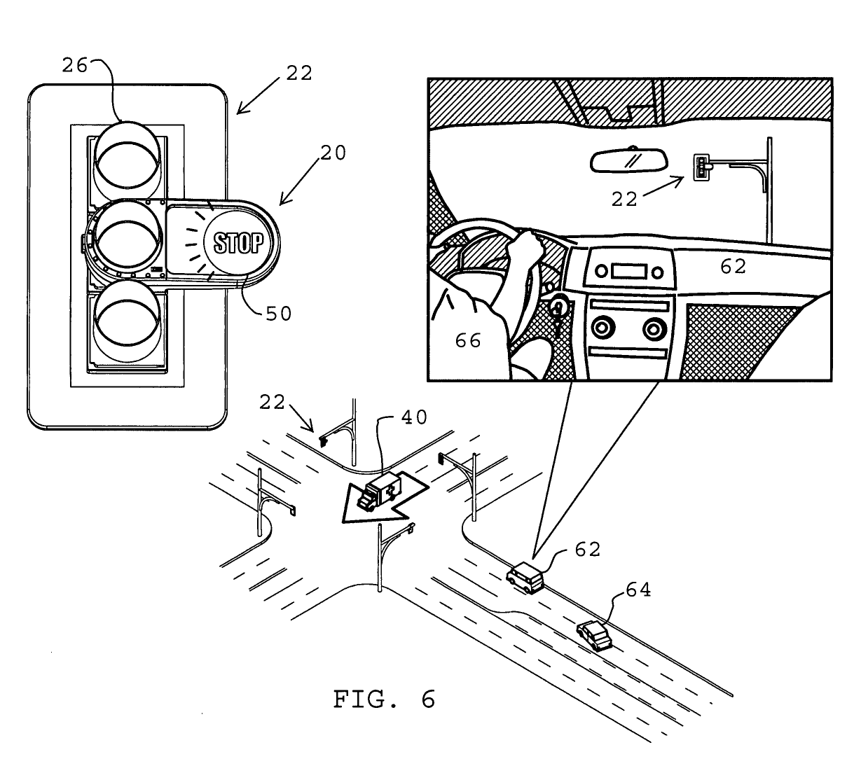

FIG. 6 illustrates one embodiment of the invention described in FIG. 4C. In this Figure, the emergency vehicle 40 is travelling on an intersecting street. The emergency vehicle 40 has transmitted an appropriate signal to activate the LED panel 50 via the sensor 36 so that the LED panel 50 displays a flashing stop insignia to alert the driver of vehicle 72 and the driver of vehicle 74 to stop before reaching the intersection. The magnified window view shown in FIG. 6 shows a view of the driver 66 of vehicle 62 in viewing the attachment 20 secured to the light signal 22.

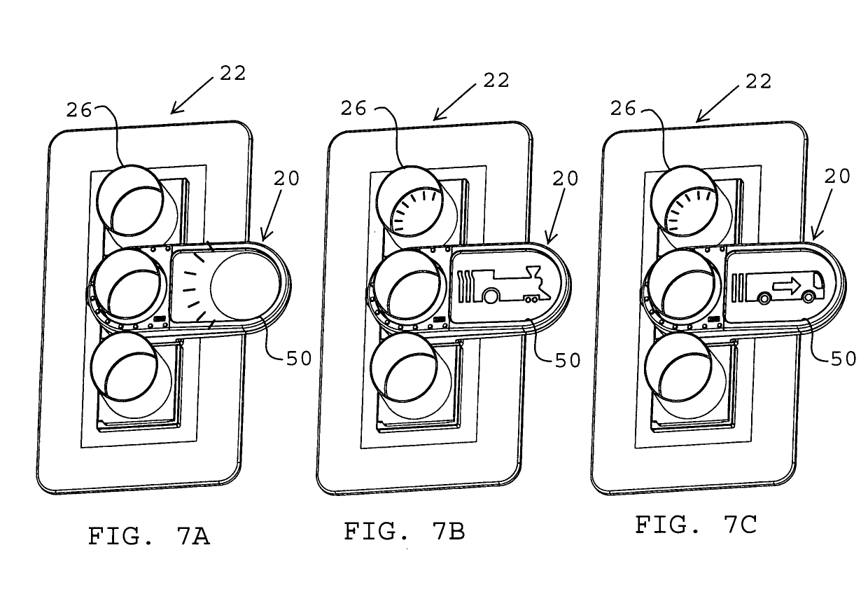

FIG. 7 illustrates embodiments of the invention that display warnings or other icons based on local area transportation issues. FIG. 7A shows the LED panel 50 displaying a flashing light to warn drivers of a power outage. In this embodiment, the auxiliary battery 46 as shown in FIG. 2 is used to provide electrical power to the LED panel 50 and all components in the event that external power sources such as from the local power utility (municipal source) are not operating. FIG. 7B shows the LED panel 50 displaying an animated train icon and which can be used at rail and light rail crossings. The LED panel 50 can include a directional indicator for drivers, which indicates the direction of travel of the train. FIG. 7C shows the LED panel 50 displaying an animated bus icon which includes a directional arrow to indicate the direction of travel of the bus.

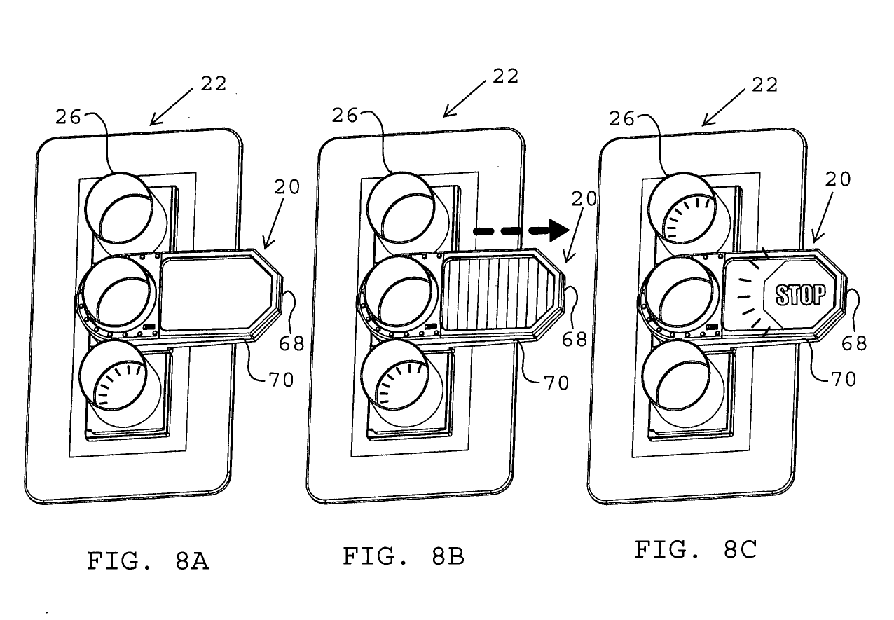

FIG. 8 illustrates further embodiments of the invention in various methods of use. In FIG. 8A, the attachment 20 includes a semi-octagonal shaped housing 70 at a distal end 68 fitted around the yellow light visor of the conventional traffic signal 22. In FIG. 8B, an emergency vehicle has activated the LED panel 50 by sending a signal received by the sensor 36 and the LED panel 50 displays a streaming configuration in the direction of the arrow 72 to alert drivers to move or merge over to one side of the road. In an alternative embodiment shown in FIG. 8C, an emergency vehicle activates the LED panel 50 to display a flashing stop insignia which alerts drivers that an emergency vehicle is crossing the driver's path.

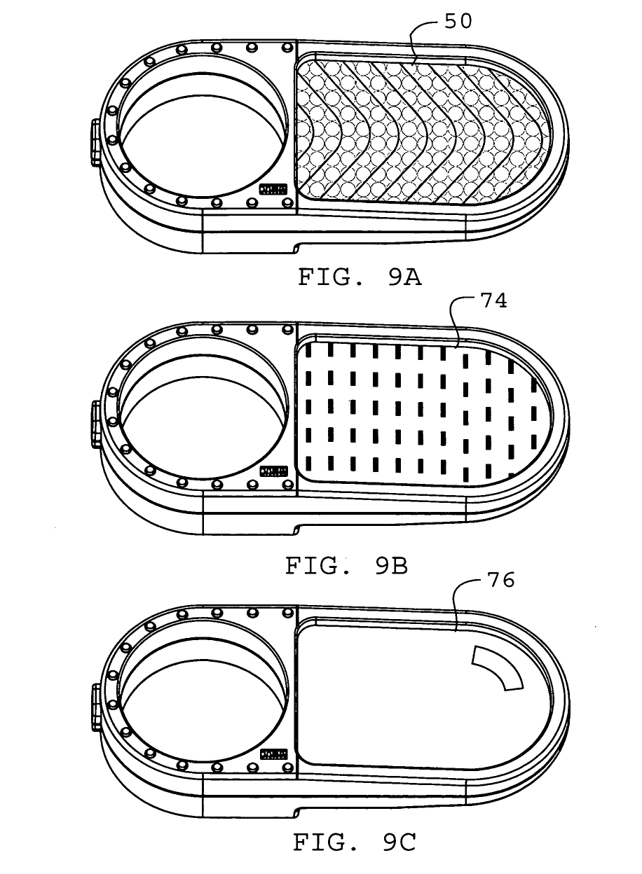

FIGS. 9A-C illustrates alternative embodiments of the inventive apparatus and system. FIG. 9A illustrates an embodiment where the LED panel 50 is configured to display alternative chevron patterns when activated so as to signal to the drivers to merge or pull over to one side of the road. FIG. 9B illustrates an embodiment where the attachment 20 includes a Liquid Crystal Display 74 (LCD) to display the warnings and messages to approaching drivers. Alternatively, the invention includes embodiments where the attachment 20 includes a Cathode-Ray Tube display 76 (CRT) as shown in FIG. 9C to display the warnings and messages to approaching drivers.

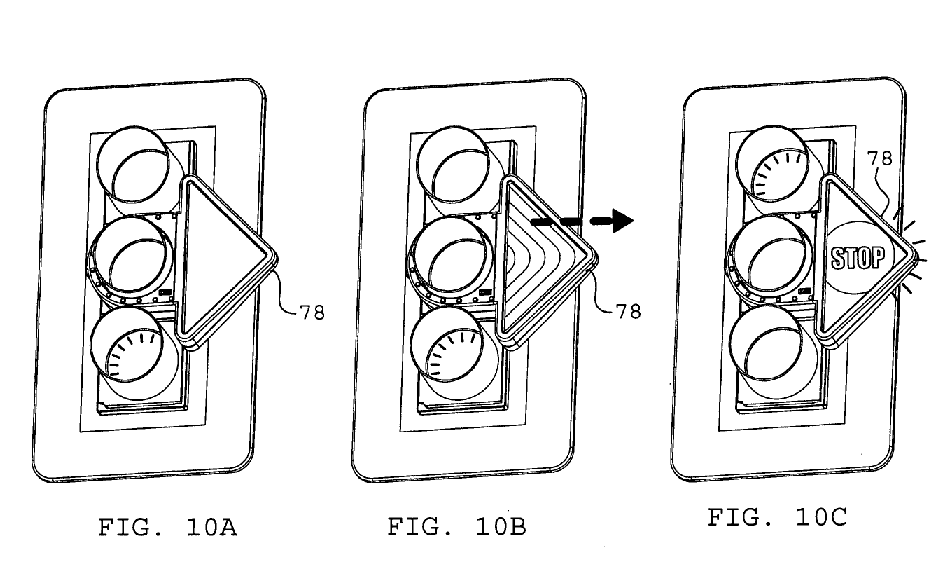

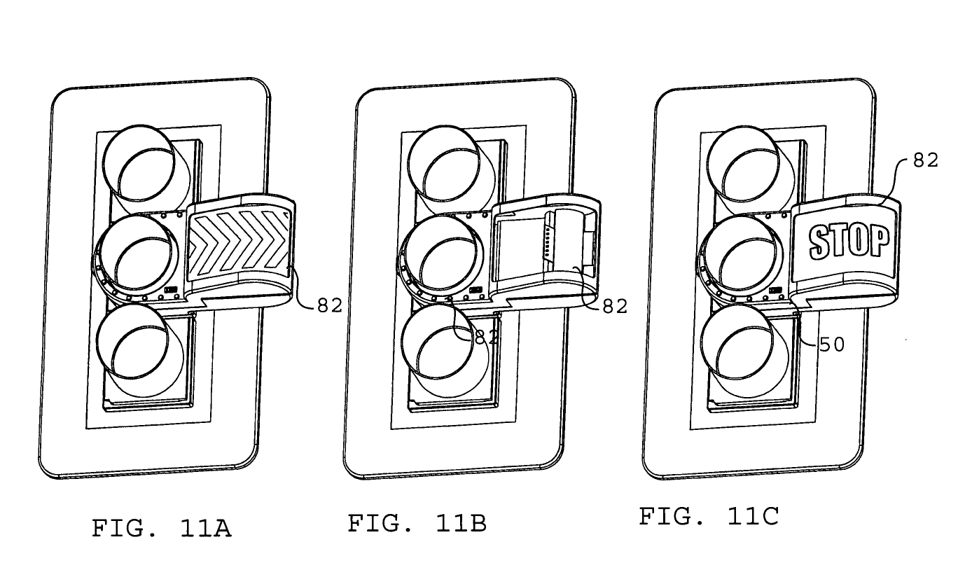

FIGS. 10A-C illustrates alternative embodiments of the invention having a pennant (or arrow) shaped housing 78. In FIG. 10A, the attachment 20 includes a pennant shaped housing 78 fitted around the yellow light visor of the conventional traffic signal 22. In FIG. 10B, an emergency vehicle has activated the LED panel 50 by sending a signal received by the sensor 36 and the LED panel 50 displays a streaming configuration in the direction of the arrow 80 to alert drivers to pull over or merge to one side of the road. In an alternative embodiment shown in FIG. 10C, an emergency vehicle activates the LED panel 50 to display a flashing stop insignia which alerts drivers that an emergency vehicle is crossing the driver's path.

FIGS. 11A-C shows further embodiments of the invention with a LED Strobing Drum apparatus 82. The LED strobing drum apparatus 82 is a LED display with a rotating LED 84 drum having a series of light emitting diodes LED's that can display a signal or other diagrams or messages. In FIG. 11B, no message is displayed such as when the light signal 22 is operating in normal traffic patterns. In FIG. 11C, the rotating LED 84 displays a stop insignia which alerts drivers that an emergency vehicle is crossing the driver's path.

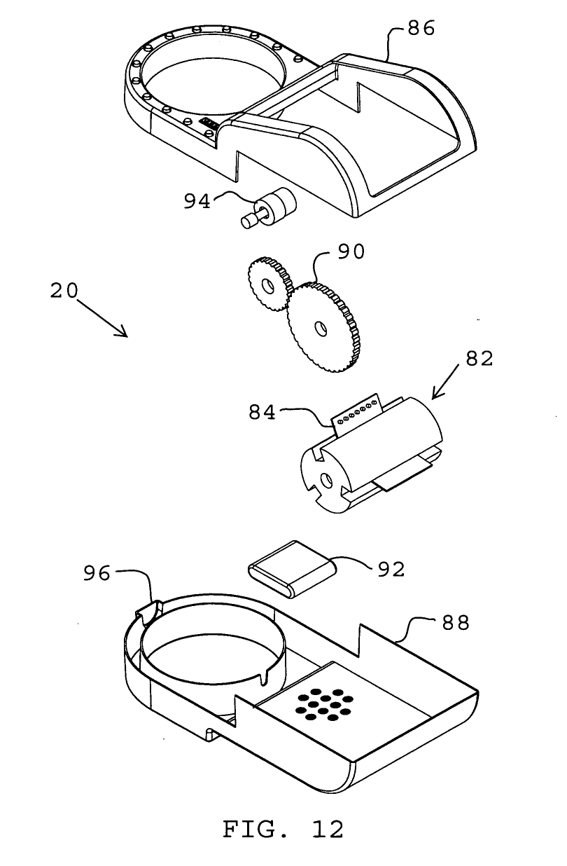

Looking at FIG. 12, an exploded view of the strobing drum 82 optional display can be seen, emphasizing the general operative components that may be included in this embodiment. The attachment 20 has a modified front housing 86 and back housing 88 to accommodate the rotating LED 84 which is attached to the strobing drum 82. A motor 94 drives the rotation of the strobing drum 82 through gearing 90 or other coupling means. The battery 92 powers the system in case of power outage. The sensor 96 operates as previously discussed. The PCB, as described above, is not shown; however, it would control the selective energizing of the rotating LEDs to produce the required civic message. The operation and control of strobing drum devices are well known in industry and are therefore not further discussed.

While particular forms of the invention have been illustrated and described, it will also be apparent to those skilled in the art that various modifications can be made without departing from the spirit and scope of the invention. Accordingly, it is not intended that the invention be limited except by the claims.

What is claimed is:

1. An attachment for a conventional traffic signal, being powered by a municipal source and having at least one signal lens shrouded by a visor, said attachment in occasional communication with an authoritative vehicle emitting a preemptive signal, comprising:
a housing configured to receive said traffic signal proximate said signal lens and provide an unobstructed view of said signal lens;
the housing further having a display for visually communicating a warning message;
a sensor for receiving said preemptive signal from said authoritative vehicle;
a controller in communication with said sensor to direct said display to show said warning message corresponding to said signal.

2. The attachment of claim 1 wherein said housing is mounted in adjoinment with said visor and provides clearance for unobscured viewing of said lens.

3. The attachment of claim 2 wherein said housing has an aperture formed therethrough to insertably receive said visor.

4. The attachment of claim 1 further comprising a speaker in communication with said controller for audibly communicating said warning message.

5. The attachment of claim 4 further wherein said speaker is mounted inside said housing.

6. The attachment of claim 1 wherein a battery temporarily provides power to said attachment when said municipal source is interrupted, permitting reception of said preemptive signal and communication of said warning message.

7. The attachment of claim 6 wherein, in the case of power interruption, said warning message is a flashing stop message when no said preemptive signal is present.

8. The attachment of claim 1 wherein said display is one of a CRT, LCD, PDP, or rotating LED.

9. The attachment of claim 1 wherein a series of selectively illuminated LEDs are visibly located on said housing and directed to illuminate individually, collectively or sequentially during the display of said warning message.

10. The attachment of claim 1 wherein said display is at least in part shaped to mimic an outer geometry of a standard street sign.

11. The attachment of claim 1 wherein said warning message corresponds to a category of said authoritative vehicle, each said category having an individualized said preemptive signal.

12. The attachment of claim 11 wherein said warning message is a graphic representation of one of said emergency vehicle, an authoritative symbol, or a known correlative graphic.

13. The attachment of claim 1 wherein said warning message animatedly indicates a directive to said citizenry, said directive is at least one of a stop directive, a yield directive, a yield right directive, a go directive, a detour directive, or an evacuation directive.

14. A method for communicating a warning message to citizenry near roadway intersections using a device having a sensor, controller and display, comprising the steps of:
providing an attachment for the device adaptable to conventional traffic signals having a plurality of lens;
installing said device unobstructively about one of said lens;
receiving a preemptive signal from an emergency vehicle via said sensor;
processing said signal in said controller to determine a warning message; and,
showing said warning message for viewing by said citizenry.

15. The method of claim 14 wherein said device further includes a series of selectively illuminated LEDs, the wherein showing said warning message includes energizing said series of selectively illuminated LEDs individually, collectively or sequentially during the display of said warning message.
